(19) United States
(12) Patent Application Publication
(10) Pub. No.: US 2009/0214972 A1
(43) Pub. Date: Aug. 27, 2009

(54) TONER COMPOSITIONS

(75) Inventors: Jordan H. Wosnick, Toronto (CA); Gabriel Iftime, Mississauga (CA); Daryl W. Vanbesien, Burlington (CA); Edward G. Zwartz, Mississauga (CA)

Correspondence Address: Xerox Corporation (CDFS), 445 Broad Hollow Rd.-Suite 420, Melville, NY, 11747, US

(73) Assignee: XEROX CORPORATION, Norwalk, CT (US)

(21) Appl. No.: 12/037,188

(22) Filed: Feb. 26, 2008

(51) Int. Cl. G03G 9/08; G03G 9/087

(52) U.S. Cl. 430/108.2; 430/108.4; 430/137.14

(57) ABSTRACT

The present disclosure provides resins having fluorescent agents suitable for use in toner compositions that are capable of imparting fluorescent properties to images printed with the toners.

### BACKGROUND

The present disclosure is generally directed to toner processes and, more specifically, to preparation of toner compositions having fluorescent components which may be useful for document security.

Fluorescent inks and dyes may be used as an authenticating feature in the document security industry. Secure documents, for example documents that are difficult to forge, may be conventionally created using inks that include fluorescent agents either alone or in combination with ordinary inks and/or pigments. Features printed using fluorescent inks are usually invisible under visible light, due to the colorless nature of the security inks or due to masking by other colorants in the document. Under ultraviolet illumination, however, the fluorescent features of the document are revealed in the form of a bright emission by the fluorescent dyes in the visible spectrum. For example, certain bank notes utilize visible features, such as holographic patches, microprinting and microtextures to conceal additional fluorescent threads and/or multi-colored emblems embedded in the bank note, which are only revealed under specific light frequencies. These features provide an increased level of security against counterfeiters by making the copying process of such a document more difficult.

Although fluorescent inks are available, the availability of fluorescent toners for xerographic and electrographic printing of security features is currently limited. For example, U.S. Pat. No. 5,554,480, the disclosure of which is hereby incorporated by reference in its entirety, describes the use of ordinary organic fluorescent dyes which are applied via non-xerographic methods (flexo printing, inkjet, and the like). Furthermore, available fluorescent toners may appear colored under visible light, which defeats their usefulness as hidden security features.

Improved methods for producing improved fluorescent toners which are suitable for use in creating security documents remain desirable.

### SUMMARY

The present disclosure provides toner compositions and methods for preparing same. In embodiments, a toner of the present disclosure may include a toner particle including a resin, at least one fluorescent agent including a lanthanide complex having a lanthanide ion and a ligand, and an optional wax. In embodiments, such a toner may also include an optional pigment.

In other embodiments, a toner of the present disclosure may include a resin, at least one fluorescent agent including a lanthanide complex having a lanthanide ion and a ligand, and an optional wax, wherein toner particles of the toner have a size of from about 1 micron to about 20 microns, and a circularity of from about 0.9 to about 0.99.

In embodiments, the fluorescent agent may be invisible under visible light. A toner of the present disclosure possessing such a fluorescent agent may emit a fluorescent band with a full width at half maximum of from about 5 nm to about 25 nm upon exposure to ultraviolet light, and may have a fluorescent lifetime of from about 0.5 milliseconds to about 10 milliseconds.

A process of the present disclosure may include contacting a resin, an optional pigment, and at least one fluorescent agent including a lanthanide complex to form a fluorescent latex, adding a wax to the fluorescent latex, and recovering fluorescent toner particles.

### DETAILED DESCRIPTION OF EMBODIMENTS

The present disclosure provides toners and processes for the preparation of toner particles having improved fluorescent characteristics. Toners of the present disclosure may, in embodiments, include a lanthanide fluorescent agent.

The lanthanide fluorescent agents described herein may be utilized with any toner within the purview of those skilled in the art. In embodiments the lanthanide fluorescent agents described herein may be utilized with conventional toners produced by melt-mixing resins, optionally with colorants, and optionally with waxes, forming agglomerated particles, and grinding or similarly treating the agglomerated particles to form toner particles. In other embodiments, the lanthanide fluorescent agents described herein may be utilized with toners produced by chemical synthesis methods, including emulsion aggregation toners and toners produced in suspensions, by chemical milling, combinations thereof, and the like.

Toners of the present disclosure may be prepared from a resin latex in combination with a lanthanide fluorescent agent, optionally colorants, and optionally wax. While the resin latex may be prepared by any method within the purview of those skilled in the art, in embodiments the resin latex may be prepared by emulsion polymerization methods, including semi-continuous emulsion polymerization, and the toner may include emulsion aggregation toners. Emulsion aggregation involves aggregation of both submicron latex and pigment particles into toner size particles, where the growth in particle size is, for example, in embodiments from about 0.1 micron to about 15 microns.

### Resin

Any monomer suitable for preparing a latex can be used in the present processes. Suitable monomers useful in forming the latex, and thus the resulting latex particles in the resin latex include, but are not limited to, styrenes, acrylates, methacrylates, butadienes, isoprenes, acrylic acids, methacrylic acids, acrylonitriles, mixtures thereof, and the like. Any monomer employed may be selected depending upon the particular latex polymer to be utilized.

In embodiments, the resin of the latex may include at least one polymer. In embodiments, at least one is from about one to about twenty and, in embodiments, from about three to about ten. In embodiments, the polymer utilized to form the latex may be a polyester resin, including the resins described in U.S. Pat. Nos. 6,593,049 and 6,756,176, the disclosures of each of which are hereby incorporated by reference in their entirety. The toners may also include a mixture of an amorphous polyester resin and a crystalline polyester resin as described in U.S. Pat. No. 6,830,860, the disclosure of which is hereby incorporated by reference in its entirety.

In embodiments, as described above, the resin may be a polyester resin formed by reacting a diol with a diacid in the presence of an optional catalyst. For forming a crystalline polyester, suitable organic diols include aliphatic diols with from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, mixtures thereof, and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-1,3-propanediol, lithio 2-sulfo-1,3-propanediol, potassio 2-sulfo-1,3-propanediol, mixture thereof, and the like. The aliphatic diol may be, for example, selected in an amount of from about 45 to about 60 mole percent of the resin, and the alkali sulfo-aliphatic diol can be selected in an amount of from about 0 to about 10 mole percent of the resin.

Examples of organic diacids or diesters selected for the preparation of the crystalline resins include oxalic acid, succinic acid, glutaric acid, adipic acid, suberic acid, azelaic acid, sebacic acid, fumaric acid, maleic acid, dodecanedioic acid, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, mixtures thereof, a diester or anhydride thereof, and an alkali sulfo-organic diacid such as the sodio, lithio or potassio salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbomethoxybenzene, sulfo-terephthalic acid, dimethyl-sulfo-terephthalate, 5-sulfo-isophthalic acid, dialkyl-sulfo-terephthalate, sulfoethanediol, 2-sulfopropanediol, 2-sulfobutanediol, 3-sulfopentanediol, 2-sulfohexanediol, 3-sulfo-2-methylpentanediol, 2-sulfo-3,3-dimethylpentanediol, sulfo-p-hydroxybenzoic acid, N,N-bis(2-hydroxyethyl)-2-amino ethane sulfonate, or mixtures thereof. The organic diacid may be selected in an amount of, for example, from about 40 to about 50 mole percent of the resin, and the alkali sulfo-aliphatic diacid can be selected in an amount of from about 0 to about 10 mole percent of the resin.

Examples of amorphous resins which may be utilized include poly(styrene-acrylate) resins, crosslinked, for example, from about 25 percent to about 70 percent, poly(styrene-acrylate) resins, poly(styrene-methacrylate) resins, crosslinked poly(styrene-methacrylate) resins, poly(styrene-butadiene) resins, crosslinked poly(styrene-butadiene) resins, polyester resins, branched polyester resins, alkali sulfonated-polyester resins, branched alkali sulfonated-polyester resins, alkali sulfonated-polyimide resins, branched alkali sulfonated-polyimide resins, alkali sulfonated poly(styrene-acrylate) resins, crosslinked alkali sulfonated poly(styrene-acrylate) resins, poly(styrene-methacrylate) resins, crosslinked alkali sulfonated-poly(styrene-methacrylate) resins, alkali sulfonated-poly(styrene-butadiene) resins, and crosslinked alkali sulfonated poly(styrene-butadiene) resins. Polyester resins may be useful in embodiments, such as poly(ethylene terephthalate), poly(propylene terephthalate), poly(diethylene terephthalate), poly(propylene-diethylene terephthalate), poly(propylene-butylene terephthalate), poly(propoxylated bisphenol-A fumarate), poly(ethoxylated bisphenol-A-fumarate), and copoly(ethoxylated bisphenol-A-maleate), and the like.

Examples of diacid or diesters selected for the preparation of amorphous polyesters include dicarboxylic acids or diesters such as terephthalic acid, phthalic acid, isophthalic acid, fumaric acid, maleic acid, succinic acid, itaconic acid, succinic acid, succinic anhydride, dodecenylsuccinic acid, dodecenylsuccinic anhydride, glutaric acid, glutaric anhydride, adipic acid, pimelic acid, suberic acid, azelic acid, dodecanedioic acid, dimethyl terephthalate, diethyl terephthalate, dimethyl isophthalate, diethyl isophthalate, dimethyl phthalate, phthalic anhydride, diethyl phthalate, dimethyl succinate, dimethyl fumarate, dimethyl maleate, dimethyl glutarate, dimethyl adipate, dimethyl dodecenylsuccinate, and combinations thereof The organic diacid or diester may be selected, for example, from about 45 to about 52 mole percent of the resin.

Examples of diols utilized in generating the amorphous polyester include 1,2-ethanediol, 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, dipropylene glycol, dibutylene, and combinations thereof. The amount of organic diol selected can vary, and may be, for example, from about 45 to about 52 mole percent of the resin.

Polycondensation catalysts which may be utilized for either the crystalline or amorphous polyesters include tetraalkyl titanates, dialkyltin oxides such as dibutyltin oxide, tetraalkyltins such as dibutyltin dilaurate, dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole percent based on the starting diacid or diester used to generate the polyester resin.

Examples of other latex resins or polymers which may be produced include, but are not limited to, poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylonitrile), and poly(styrene-butyl acrylate-acrylonitrile-acrylic acid), and combinations thereof. The polymer may be block, random, or alternating copolymers.

In addition, polyester resins obtained from the reaction of bisphenol A and propylene oxide or propylene carbonate, and in particular including such polyesters followed by the reaction of the resulting product with fumaric acid (as disclosed in U.S. Pat. No. 5,227,460, the entire disclosure of which is incorporated herein by reference), and branched polyester resins resulting from the reaction of dimethylterephthalate with 1,3-butanediol, 1,2-propanediol, pentaerythritol, trimethylolethane, trimethylolpropane, 1,3,5-trihydroxymethylbenzene, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, and other trihydric or higher polyhydric alcohol components may also be used.

In embodiments, an unsaturated polyester resin may be utilized as a latex resin. Examples of such resins include those disclosed in U.S. Pat. No. 6,063,827, the disclosure of which is hereby incorporated by reference in its entirety. Exemplary unsaturated polyester resins include, but are not limited to, poly(propoxylated bisphenol A co-fumarate), poly(ethoxylated bisphenol A co-fumarate), poly(butyloxylated bisphenol A co-fumarate), poly(co-propoxylated bisphenol A co-ethoxylated bisphenol A co-fumarate), poly(1,2-propylene fumarate), poly(propoxylated bisphenol A co-maleate), poly(ethoxylated bisphenol A co-maleate), poly(butyloxylated bisphenol A co-maleate), poly(co-propoxylated bisphenol A co-ethoxylated bisphenol A co-maleate), poly(1,2-propylene maleate), poly(propoxylated bisphenol A co-itaconate), poly(ethoxylated bisphenol A co-itaconate), poly(butyloxylated bisphenol A co-itaconate), poly(co-propoxylated bisphenol A co-ethoxylated bisphenol A co-itaconate), poly(1,2-propylene itaconate), and combinations thereof.

In embodiments, a suitable polyester resin which may be utilized may be a poly(propoxylated bisphenol A co-furmarate) resin having a degree of polymerization from about 12 to about 240.

The unsaturated polyester resin may be prepared by (i) reacting an organic diol with a cyclic alkylene carbonate in the presence of a first catalyst to thereby form a polyalkoxy diol, and (ii) optionally adding thereto a further amount of cyclic alkylene carbonate in the presence of a second catalyst, and (iii) subsequently polycondensing the resulting mixture with a dicarboxylic acid.

An example of a linear propoxylated bisphenol A fumarate resin which may be utilized as a latex resin is available under the trade name SPARII from Resana S/A Industrias Quimicas, Sao Paulo Brazil. Other propoxylated bisphenol A fumarate resins that may be utilized and are commercially available include GTUF and FPESL-2 from Kao Corporation, Japan, and EM 181635 from Reichhold, Research Triangle Park, North Carolina and the like.

In embodiments, a branched polyester resin may be utilized. Such resins include those disclosed in U.S. Pat. No. 6,291,122, the disclosure of which is hereby incorporated herein by reference in its entirety. Such a branched resin may have a branching component such as a polyhydric alcohol such as trimethylolethane, trimethylolpropane, 1,3,5-trihydroxymethylbenzene, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, and other trihydric or higher polyhydric alcohol components. In embodiments, the branched polyester resin may be a branched poly(propoxylated bisphenol A co-fumarate) where the main chain has an overall degree of polymerization from about 12 to about 240 and the branched portion has an overall degree of polymerization from about 1 to about 240.

A latex resin suitable for use herein may be formed by any method within the purview of those skilled in the art. In embodiments, emulsion polymerization processes may be utilized to form the latex resin. In the emulsion polymerization process, the reactants for forming the resin may be added to a suitable reactor, such as a mixing vessel. The appropriate amount of monomers, stabilizer, surfactant(s), initiator, if any, chain transfer agent, if any, and wax, if any, and the like may be combined in the reactor and the emulsion polymerization process may be allowed to begin. Reaction conditions selected for effecting the emulsion polymerization include temperatures of, for example, from about 45° C. to about 120° C., in embodiments from about 60° C. to about 90° C. In embodiments the polymerization may occur at elevated temperatures within about 10 percent of the melting point of any wax present, for example from about 60° C. to about 85° C., in embodiments from about 65° C. to about 80° C., to permit the wax to soften thereby promoting dispersion and incorporation into the emulsion.

Nanometer size particles may be formed, from about 50 nm to about 800 nm in volume average diameter, in embodiments from about 100 nm to about 400 nm in volume average diameter, as determined, for example, by a Brookhaven nanosize particle analyzer. After formation of the latex particles, the latex particles may be utilized to form a toner.

In other embodiments, pre-formed or pre-made resins may be obtained and utilized to form toners utilizing methods within the purview of those skilled in the art.

### Toner Particles

Once obtained, a latex resin described above may be utilized to form a toner. In embodiments, a latex of the present disclosure may be combined with a colorant including a lanthanide fluorescent agent, an optional wax, an optional surfactant, and other optional ingredients, to produce a toner by processes within the purview of those skilled in the art utilizing methods described above including, but not limited to, emulsion aggregation, phase inversion, solvent flashing, combinations thereof, and the like. For example, in embodiments, the latex resin may be combined with a colorant including a lanthanide complex of the present disclosure and optional wax and other ingredients to produce a resin having the lanthanide fluorescent agent, and then combined with additional ingredients such as additional surfactants, stabilizers, other optional ingredients, and the like, and subjected to aggregation, coalescence, and/or washing to produce a toner.

### Lanthanide Fluorescent Agents

In accordance with the present disclosure, the toner possesses a colorant including a lanthanide complex. Lanthanide complexes for use as fluorescent agents may be prepared from any of the lanthanide elements. In embodiments, the fluorescent agent may be prepared from praseodymium, neodymium, samarium, europium, gadolinium, terbium, dysprosium, holmium, erbium, thulium and ytterbium. Complexes containing lanthanide elements which have f-electrons may be particularly useful since they are capable of emitting suitable fluorescence. Some lanthanide elements may be less suitable for use as fluorescent agents. For example, lanthanum does not include any f-electrons, lutetium has a full f-shell and d-electrons, and promethium has no stable isotopes and does not occur naturally. Although cerium may be used, the fluorescence of cerium emits a broad spectrum that is more difficult to analyze than relatively narrow spectrum lines of other lanthanide elements.

More specifically, lanthanide complexes may be provided which emit green, orange, red or near-infrared (NIR, which is at a spectrum of from about 800 to about 1500 nm) fluorescent colors, providing for a range of custom fluorescent color toners spanning a wide color gamut.

Under normal visible light illumination, the lanthanide ions do not absorb light efficiently, thereby making them practically invisible to the human eye. Combining the lanthanide ions with a ligand, in embodiments an organic ligand, allows the resulting complex to absorb the light and transfer the energy to the lanthanide ions. The lanthanide complexes of the present disclosure thus appear colorless under normal light but undergo energy transfer when bound to lanthanide ions, leading to fluorescence at a wavelength widely separated from that of the absorbed light. This wide wavelength separation, a unique feature of lanthanides, makes colorless lanthanide fluorescent agents possible. In contrast, only blue-fluorescent organic dyes may be made completely colorless under normal illumination. It is extremely difficult, if not impossible, to make yellow or red emitting organic dyes appear colorless under normal illumination.

Various types of organic ligands can be used to form suitable lanthanide complexes, such as bis(pyrazolyl)pyridine, tris(2,2,6,6,-tetramethyl-3,5-heptanedionato) chelate, tris(2,2,6,6,-tetrakis(trifluoromethyl)-3,5 -heptanedionato) chelate, combinations thereof, and the like. Examples of suitable methods for forming lanthanide complexes include those disclosed in U.S. Pat. No. 5,435,937, the disclosure of which is hereby incorporated by reference herein in its entirety. Specific chelates may be chosen based on a variety of factors such as a triplet energy level similar to but slightly higher than the resonant energy level of the lanthanide ion, miscibility of the fluorescent lanthanide complex with the latex resin and other components of the toner, the desired color, and the like.

Absorbance and fluorescence spectra of lanthanide complexes illustrate fluorescence peaks which are narrower than those from organic dyes of comparable fluorescence emission ranges. For example, lanthanide complexes have sharp fluorescence spectra with a number of distinct peaks. This feature makes security toners based on lanthanide complexes difficult to forge or duplicate utilizing ordinary fluorescent dyes. Although the fluorescent images or text may be superficially similar, evaluation using a simple spectrofluorimeter would reveal clear differences between the sharp lanthanide bands having a full width at half maximum of from about 5 nm to about 25 nm, in embodiments from about 10 nm to about 20 nm, and the broad bands obtained with organic dyes, which may have band widths of about 100 nm. Narrow fluorescence bands of lanthanide ions allow for easier fluorescence analysis since narrower peaks denote emission of clearly definable colors. Since emitted colors of lanthanide ions during fluorescence are more easily identified this property makes these compounds suitable for use in security dyes and/or toners.

In embodiments, NIR fluorescence from lanthanides may be useful for document security, as this form of fluorescence cannot be seen by the naked eye. The incorporation of a NIR lanthanide fluorescent agent into a toner would allow the xerographic printing of documents that contain a security feature that can only be detected by a combination of UV excitation (to generate fluorescence) and NIR-sensitive detection (using commercially available charge-coupled devices (CCDs) or digital cameras that respond to these wavelengths).

Moreover, in embodiments, multiple lanthanide complexes having unique fluorescent signatures may be used in combination as components in a toner to enable document fingerprinting, for example, in embodiments, the use of a specific invisible identifying mark on a document that is readable upon exposure to UV light or by use of a identity-checking machine to verify that a document is authentic and the same as the originally issued document. A further security advantage can be obtained by combining multiple lanthanide fluorescent agents within a single security printing scheme. The narrow, monochromatic fluorescence bands that arise from lanthanide fluorescence may be applied to create customized combinations of lanthanide fluorescent agents within a single xerographic toner (a unique security “barcode”). Customized, invisible fluorescent toners with a wide range of luminescence properties would be especially useful in the security printing field. For example, in a toner containing two or more lanthanide fluorescent agents, the combination of fluorescence spectral features (peak position, intensity, and width) of each agent would lead to an overall fluorescence spectrum that is unique to the particular combination of lanthanide fluorescent agents and would be difficult to reproduce without knowing the identities and proportions of the lanthanide fluorescent agents used. The resulting unique fluorescent features, which may be referred to, in embodiments, as a “barcode”, would be valuable as a security feature.

Upon combining a lanthanide complex with a latex resin, a fluorescent latex is formed. This fluorescent latex, upon combination with further components of toner particles, may be utilized to produce a fluorescent toner.

### Wax

Wax dispersions may also be added during formation of a latex in an emulsion aggregation synthesis or when combining a latex, with a lanthanide complex to form a fluorescent toner. Suitable waxes include, for example, submicron wax particles in the size range of from about 50 to about 1000 nanometers, in embodiments of from about 100 to about 500 nanometers in volume average diameter, suspended in an aqueous phase of water and an ionic surfactant, nonionic surfactant, or combinations thereof. The ionic surfactant or nonionic surfactant may be present in an amount of from about 0.1 to about 20 percent by weight, and in embodiments of from about 0.5 to about 15 percent by weight of the wax.

The wax dispersion according to embodiments of the present disclosure may include, for example, a natural vegetable wax, natural animal wax, mineral wax, and/or synthetic wax. Examples of natural vegetable waxes include, for example, carnauba wax, candelilla wax, Japan wax, and bayberry wax. Examples of natural animal waxes include, for example, beeswax, punic wax, lanolin, lac wax, shellac wax, and spermaceti wax. Mineral waxes include, for example, paraffin wax, microcrystalline wax, montan wax, ozokerite wax, ceresin wax, petrolatum wax, and petroleum wax. Synthetic waxes of the present disclosure include, for example, Fischer-Tropsch wax, acrylate wax, fatty acid amide wax, silicone wax, polytetrafluoroethylene wax, polyethylene wax, polypropylene wax, and combinations thereof.

Examples of polypropylene and polyethylene waxes include those commercially available from Allied Chemical and Baker Petrolite, wax emulsions available from Michelman Inc. and the Daniels Products Company, EPOLENE N-15 commercially available from Eastman Chemical Products, Inc., VISCOL 550-P, a low weight average molecular weight polypropylene available from Sanyo Kasel K.K., and similar materials. In embodiments, commercially available polyethylene waxes possess a molecular weight (Mw) of from about 100 to about 5000, and in embodiments of from about 250 to about 2500, while the commercially available polypropylene waxes have a molecular weight of from about 200 to about 10,000, and in embodiments of from about 400 to about 5000.

In embodiments, the waxes may be functionalized. Examples of groups added to functionalize waxes include amines, amides, imides, esters, quaternary amines, and/or carboxylic acids. In embodiments, the functionalized waxes may be acrylic polymer emulsions, for example, JONCRYL 74, 89, 130, 537, and 538, all available from Johnson Diversey, Inc, or chlorinated polypropylenes and polyethylenes commercially available from Allied Chemical, Baker Petrolite Corporation and Johnson Diversey, Inc. The wax may be present in an amount of from about 0.1 to about 30 percent by weight, and in embodiments from about 2 to about 20 percent by weight of a toner including a wax, optionally in a resin utilized to form such a toner.

### Surfactants

Surfactants which may be utilized in preparing resins and toners with the processes of the present disclosure include anionic, cationic, and/or nonionic surfactants. Such surfactants may find use in forming latex resins in emulsion polymerization synthesis methods, and may also find use in forming toner particles in emulsion aggregation processes, phase inversion processes, and the like.

Anionic surfactants which may be utilized include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abitic acid available from Aldrich, NEOGEN R™, NEOGEN SC™ obtained from Daiichi Kogyo Seiyaku, combinations thereof, and the like. Other suitable anionic surfactants include, in embodiments, DOWFAX™ 2A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants may be utilized in embodiments.

Examples of nonionic surfactants include, but are not limited to alcohols, acids and ethers, for example, polyvinyl alcohol, polyacrylic acid, methalose, methyl cellulose, ethyl cellulose, propyl cellulose, hydroxyl ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, mixtures thereof, and the like. In embodiments commercially available surfactants from Rhone-Poulenc such as IGEPAL CA-21™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™ can be selected.

Examples of cationic surfactants include, but are not limited to, ammoniums, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, and C12, C15, C17 trimethyl ammonium bromides, mixtures thereof, and the like. Other cationic surfactants include cetyl pyridinium bromide, halide salts of quaternized polyoxyethylalkylamines, dodecylbenzyl triethyl ammonium chloride, and the like, and mixtures thereof The choice of particular surfactants or combinations thereof, as well as the amounts of each to be used, is within the purview of those skilled in the art.

### Stabilizers

In embodiments, it may be desirable to add a stabilizer to the materials utilized to form the latex resin and/or toner to achieve better emulsion polymerization results. Additional stabilizers that may be utilized include bases such as metal hydroxides, including sodium hydroxide, potassium hydroxide, ammonium hydroxide, and optionally combinations thereof Also useful as a stabilizer is sodium carbonate, sodium bicarbonate, calcium carbonate, potassium carbonate, ammonium carbonate, combinations thereof, and the like. In embodiments a stabilizer may include ammonium hydroxide.

Where present, the stabilizer may be added in amounts from about 0.01 to about 5 percent by weight of the resin, in embodiments from about 0.05 to about 2 percent by weight of the resin.

### Additional Colorants

In embodiments, toners of the present disclosure may include additional colorants. Such colorants include, for example, various known suitable colorants, such as dyes, pigments, mixtures of dyes, mixtures of pigments, mixtures of dyes and pigments, and the like, may be included in the toner. The colorant may be included in the toner in an amount of, for example, about 0.1 to about 35 percent by weight of the toner, or from about 1 to about 15 weight percent of the toner, or from about 3 to about 10 percent by weight of the toner.

As examples of suitable colorants, mention may be made of carbon black like REGAL 330®; magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™; Northern Pigments magnetites, NP-604™, NP-608™; Magnox magnetites TMB-100™, or TMB-104™; and the like. As colored pigments, there can be selected cyan, magenta, yellow, red, green, brown, blue or mixtures thereof Generally, cyan, magenta, or yellow pigments or dyes, or mixtures thereof, are used. The pigment or pigments are generally used as water based pigment dispersions.

Specific examples of pigments include SUNSPERSE 6000, FLEXIVERSE and AQUATONE water based pigment dispersions from SUN Chemicals, HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & Company, and the like. Generally, colorants that can be selected are black, cyan, magenta, or yellow, and mixtures thereof Examples of magentas are 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyans include copper tetra(octadecyl sulfonamido) phthalocyanine, x-copper phthalocyanine pigment listed in the Color Index as CI 74160, CI Pigment Blue, and Anthrathrene Blue, identified in the Color Index as CI 69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan components may also be selected as colorants. Other known colorants can be selected, such as Levanyl Black A-SF (Miles, Bayer) and Sunsperse Carbon Black LHD 9303 (Sun Chemicals), and colored dyes such as Neopen Blue (BASF), Sudan Blue OS (BASF), PV Fast Blue B2G01 (American Hoechst), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing, and the like.

### Reaction Conditions

The fluorescent lanthanide complexes of the present disclosure may be combined with a latex resin, optional waxes, stabilizers, surfactants, and other additives, utilizing any method within the purview of those skilled in the art to form toner particles. In embodiments, an emulsion aggregation (EA) method may be utilized whereby toners may be formed by aggregating a colorant with a latex polymer formed by emulsion polymerization. Examples of emulsion/aggregation/coalescing processes for the preparation of toners are illustrated in U.S. Pat. Nos. 5,403,693, 5,418,108, 5,364,729, and 5,346,797, the disclosures of each of which are hereby incorporated by reference in their entirety. Other processes are disclosed in U.S. Pat. Nos. 5,527,658, 5,585,215, 5,650,255, 5,650,256 and 5,501,935, the disclosures of each of which are hereby incorporated by reference in their entirety.

In other embodiments, a phase inversion process may be utilized to form toner particles. Such a process may include forming an emulsion including a disperse phase possessing a first composition and a continuous phase including molten one or more ingredients of a toner composition, performing a phase inversion to create a phase inversed emulsion including a disperse phase including toner-sized droplets possessing the molten one or more ingredients of the toner composition and a continuous phase including a second composition, and solidifying the toner-sized droplets to result in toner particles. The disperse and continuous phases may possess solvents, including ketones and/or alcohols to dissolve the resins or, in embodiments, may be solvent-free, in which case aqueous compositions may be utilized. Such solvent-free processes are disclosed, for example, in U.S. Patent Application Publication No. 2007/0141494, the disclosure of which is hereby incorporated by reference in its entirety. Such a phase inversed emulsion may include a disperse phase including toner-sized droplets possessing molten ingredients of a toner composition and a continuous phase including an aqueous composition.

In embodiments, a polyester resin emulsion may be generated by a solvent flashing method by, for example, dissolving the polyester in a solvent, such as ketones and/or alcohols. In other embodiments, the polyester may be dissolved in a water miscible solvent, such as acetone, tetrahydrofuran, combinations thereof, and the like. The resin and solvent may, in embodiments, be mixed with water at a temperature of, for example, from about 70° C. to about 90° C., in embodiments from about 75° C. to about 84° C., whereby the solvent is removed by distillation thereof and thereby permitting the formation of the polyester in water as a stable emulsion, and thereafter mixing the polyester obtained with a colorant and accomplishing aggregation and coalescence thereof as illustrated herein and as disclosed, for example, in U.S. Pat. Nos. 7,029,817, 5,290,654, 5,278,020, 5,308,734, 5,370,963, 5,344,738, 5,403,693, 5,418,108, 5,364,729, 5,346,797, 5,348,832, and 5,405,728, the disclosures of each of which are hereby incorporated by reference in their entirety.

### Aggregation and Coalescence

The mixture of latex, lanthanide complex, optional wax, and optional additional colorant, may be subsequently treated to form toner particles.

The pH of the mixture may be lowered to from about 2.5 to about 6 and in embodiments, to from about 3.3 to about 5.5 with, for example, an acid to coalesce the toner aggregates. Suitable acids include, for example, nitric acid, sulfuric acid, hydrochloric acid, citric acid or acetic acid. The amount of acid added may be from about 4 to about 30 percent by weight of the mixture, and in embodiments from about 5 to about 15 percent by weight of the mixture.

The mixture may be coalesced. Coalescing may include providing additional surfactant and water, stirring and heating at a temperature of from about 60° C. to about 99° C., for a period of from about 0.5 to about 6 hours, and in embodiments from about 2 to about 5 hours. Coalescing may be accelerated by additional stirring.

The mixture may be cooled, washed and dried. Cooling may be at a temperature of from about 20° C. to about 40° C., in embodiments from about 22° C. to about 30° C. over a period time from about 1 hour to about 8 hours, and in embodiments from about 1.5 hours to about 5 hours.

In embodiments, cooling a coalesced toner slurry includes quenching by adding a cooling media such as, for example, ice, dry ice and the like, to effect rapid cooling to a temperature of from about 20° C. to about 40° C., and in embodiments of from about 22° C. to about 30° C.

The coalesced toner may then be washed. The washing may be carried out at a pH of from about 7 to about 12, and in embodiments at a pH of from about 9 to about 11. The washing is at a temperature of from about 20° C. to about 70° C., and in embodiments from about 25° C. to about 50° C. The washing may include filtering and reslurrying a filter cake including toner particles in deionized water, optionally with the inclusion of additional surfactant. The filter cake may be washed one or more times by deionized water, or washed by a single deionized water wash at a pH of about 4 wherein the pH of the slurry is adjusted with an acid, and followed optionally by one or more deionized water washes.

The washed slurry may then be dried. Drying may be carried out at a temperature of from about 20° C. to about 75° C., and in embodiments of from about 45° C. to about 60° C. The drying may be continued until the moisture level of the particles is below a set target of about 1% by weight, in embodiments of less than about 0.7% by weight.

In embodiments, aggregating agents may be included in forming toner particles of the present disclosure. Any aggregating agent capable of causing complexation might be used in forming toner of the present disclosure. In embodiments, multi-valent salts can be selected to aggregate polyester colloids with a colorant to enable the formation of a toner composite. The salts may be added over a period of time from about 1 minute to about 60 minutes, in embodiments from about 1.25 minutes to about 20 minutes, depending on the processing conditions. Such salts include, for example, beryllium chloride, beryllium bromide, beryllium iodide, beryllium acetate, beryllium sulfate, magnesium chloride, magnesium bromide, magnesium iodide, magnesium acetate, magnesium sulfate, calcium chloride, calcium bromide, calcium iodide, calcium acetate, calcium sulfate, strontium chloride, strontium bromide, strontium iodide, strontium acetate, strontium sulfate, barium chloride, barium bromide, barium iodide, and optionally mixtures thereof. Examples of transition metal salts or cations which may be utilized as aggregating agent include acetates of vanadium, niobium, tantalum, chromium, molybdenum, tungsten, manganese, iron, ruthenium, cobalt, nickel, copper, zinc, cadmium or silver; acetoacetates of vanadium, niobium, tantalum, chromium, molybdenum, tungsten, manganese, iron, ruthenium, cobalt, nickel, copper, zinc, cadmium or silver; sulfates of vanadium, niobium, tantalum, chromium, molybdenum, tungsten, manganese, iron, ruthenium, cobalt, nickel, copper, zinc, cadmium or silver; and aluminum salts such as aluminum acetate, aluminum halides such as polyaluminum chloride, mixtures thereof, and the like. Examples of main group metal salts which may be utilized as aggregating agents include polyaluminum halides such as polyaluminum chloride (PAC), or the corresponding bromide, fluoride, or iodide, polyaluminum silicates such as polyaluminum sulfo silicate (PASS), and water soluble metal salts including aluminum chloride, aluminum nitrite, aluminum sulfate, potassium aluminum sulfate, calcium acetate, calcium chloride, calcium nitrite, calcium oxalate, calcium sulfate, magnesium acetate, magnesium nitrate, magnesium sulfate, zinc acetate, zinc nitrate, zinc sulfate, combinations thereof, and the like. In embodiments, suitable coagulants include a polymetal salt such as, for example, polyaluminum chloride (PAC), polyaluminum bromide, or polyaluminum sulfosilicate. The polymetal salt can be in a solution of nitric acid, or other diluted acid solutions such as sulfuric acid, hydrochloric acid, citric acid or acetic acid. The coagulant may be added in amounts from about 0.01 to about 5 percent by weight of the toner, and in embodiments from about 0.1 to about 3 percent by weight of the toner.

### Other Additives

Further optional additives which may be combined with a toner include any additive to enhance the properties of toner compositions. Included are surface additives, color enhancers, etc. Surface additives that can be added to the toner compositions after washing or drying include, for example, metal salts, metal salts of fatty acids, colloidal silicas, metal oxides, strontium titanates, combinations thereof, and the like, which additives are each usually present in an amount of from about 0.1 to about 10 weight percent of the toner, in embodiments from about 0.5 to about 7 weight percent of the toner. Examples of such additives include, for example, those disclosed in U.S. Pat. Nos. 3,590,000, 3,720,617, 3,655,374 and 3,983,045, the disclosures of each of which are hereby incorporated by reference in their entirety. Other additives include zinc stearate and AEROSIL R972® available from Degussa. The coated silicas of U.S. Pat. No. 6,190,815 and U.S. Pat. No. 6,004,714, the disclosures of each of which are hereby incorporated by reference in their entirety, can also be selected in amounts, for example, of from about 0.05 to about 5 percent by weight of the toner, in embodiments from about 0.1 to about 2 percent by weight of the toner. These additives can be added during the aggregation or blended into the formed toner product.

In embodiments, an aggregation method may be utilized whereby the latex resin particles are formed, and then aggregated and coalesced with a lanthanide complex and optional wax and other additives to form toner particles. In embodiments, such a process may include combining from about 100 grams to about 500 grams of at least one resin, in other embodiments from about 150 grams to about 250 grams of at least one resin, with from about 0.5 grams to about 50 grams of a lanthanide complex, in embodiments from about 1 grams to about 10 grams of a lanthanide complex and from about 50 grams to about 150 grams of a wax, in embodiments from about 75 grams to about 125 grams of a wax. The components may be combined in a suitable solvent, such as a ketone, alcohol, ester, combinations thereof, and the like, and heated to a temperature of from about 50° C. to about 90° C., in embodiments from about 60° C. to about 80° C., in some embodiments about 70° C.

The solution thus produced may then be combined with a separate aqueous solution, in embodiments including a stabilizer and a surfactant in deionized water, to produce an emulsion of the latex having the lanthanide fluorescent agent. In embodiments the two solutions may be subjected to homogenization by mixing at high shear, in embodiments from about 8,000 rpm to about 12,000 rpm, in other embodiments from about 9,000 rpm to about 11,000 rpm, in other embodiments about 10,000 rpm, for from about 15 minutes to about 60 minutes, in embodiments from about 20 minutes to about 45 minutes, in embodiments about 30 minutes. The reaction mixture may then be distilled at a temperature of from about 60° C. to about 100° C., in embodiments from about 70° C. to about 90° C., in some embodiments about 80° C., for a period of time from about 1 hour to about 3 hours, in embodiments about 2 hours. The resulting emulsion may be stirred for a period of time from about 12 hours to about 18 hours, with the resulting latex possessing a lanthanide complex isolated by filtering, centrifuging, decanting, combinations thereof, and the like. Resulting particles may have a particle size of from about 20 nm to about 500 nm, in embodiments from about 50 nm to about 250 nm, and a solids content of from about 20% to about 25%, in embodiments from about 21% to about 24%, in embodiments about 23.5%.

Toner particles produced utilizing a latex of the present disclosure may have a size of about 1 micron to about 20 microns, in embodiments about 2 microns to about 15 microns, in embodiments about 3 microns to about 7 microns, in some embodiments about 5.9 microns. Toner particles of the present disclosure may have a circularity of from about 0.9 to about 0.99, in embodiments from about 0.92 to about 0.98, in some embodiments about 0.94.

### Advantages

Following the methods of the present disclosure, toner particles may be obtained having several advantages compared with conventional toners. Fluorescent toners according to the present disclosure when exposed to UV light have a fluorescent lifetime of from about 0.5 milliseconds to about 10 milliseconds, while conventional fluorescent dyes have a fluorescent lifetime of from about 1 nanosecond to about 10 nanoseconds. Moreover, as described above, the lanthanide complexes utilized in accordance with the present disclosure have narrow band peaks, with a full width at half maximum of from about 5 nm to about 25 nm, in embodiments from about 10 nm to about 20 nm, compared with the broad bands obtained with organic dyes (which have much wider band widths of about 100 nm).

The longer fluorescence lifetime of the lanthanide complex, which may be 1,000,000 times longer than the lifetime of an organic dye, and narrow band peaks of the lanthanide complex, allows for easier detection and identification of the toners having lanthanide fluorescent agents, which in turn allows for use of conventional fluorescence devices and obviates the use of expensive laboratory equipment. For example, luminescence lifetime measurements may be carried out using simple devices, for example the Molecular Devices Gemini EM, and thus the luminescence lifetime may also be used to distinguish a lanthanide fluorescent complex from a forged organic dye fluorescent in a document-security setting.

Further, lanthanide complexes have a relatively wide Stokes shift, the gap between the absorption and emission wavelengths. The wide Stokes shift allows the lanthanide complexes to remain colorless under normal illumination and display a color through fluorescence under ultraviolet illumination. In contrast, conventional organic-based fluorescent dyes have narrow Stokes shift, and as a result, absorb and emit light at similar frequencies. Thus, it is extremely difficult to make yellow and/or red-fluorescent organic dyes which appear colorless under normal lighting conditions, because the absorption of visible light in the range of from about 400 nm to about 700 nm by such dyes is strong. Only blue-emitting fluorescent organic dyes appear colorless under normal illumination, because their absorption is solely in the ultraviolet range of the spectrum and does not extend to visible wavelengths. Thus, the wide Stokes shift is yet another property of the lanthanide complexes which makes these compounds more suitable for security document creation when compared with organic based dyes.

A further advantage is from the light fastness of lanthanide fluorescent agents, especially in the red and NIR ranges; comparable organic dyes may be easily photo-bleached, meaning that their fluorescence fades after repeated illumination by ultraviolet or visible light. Thus, the lightfastness of lanthanide fluorescent agents makes them more suitable for security document creation because their fluorescence is more likely to persist after repeated examination with ultraviolet or visible light.

### Uses

The resins possessing a lanthanide fluorescent complex according to the present disclosure may be used to manufacture various types of toners which may be used in a variety of imaging devices including printers, copy machines, and the like. Toners having lanthanide fluorescent complexes may be used for the creation of various security documents, such as for creating luminescent glyphs, barcodes, and other security printing schemes readable by machines or otherwise, which form unique fluorescence identifying codes that are difficult to counterfeit. The printed documents may then be examined for authenticity by revealing security features under UV illumination which are not visible under normal lighting conditions.

The toners generated in accordance with the present disclosure are excellent for imaging processes, with excellent image resolution, acceptable signal-to-noise ratio, image uniformity and security features which may be revealed by application of UV energy. Further, toners of the present disclosure can be selected for electrophotographic imaging and printing processes such as digital imaging systems and processes.

Developer compositions can be prepared by mixing the toners obtained with the processes disclosed herein with known carrier particles, including coated carriers, such as steel, ferrites, and the like. Such carriers include those disclosed in U.S. Pat. Nos. 4,937,166 and 4,935,326, the entire disclosures of each of which are incorporated herein by reference. The carriers may be present from about 2 percent by weight of the toner to about 8 percent by weight of the toner, in embodiments from about 4 percent by weight to about 6 percent by weight of the toner. The carrier particles can also include a core with a polymer coating thereover, such as polymethylmethacrylate (PMMA), having dispersed therein a conductive component like conductive carbon black. Carrier coatings include silicone resins such as methyl silsesquioxanes, fluoropolymers such as polyvinylidiene fluoride, mixtures of resins not in close proximity in the triboelectric series such as polyvinylidiene fluoride and acrylics, thermosetting resins such as acrylics, combinations thereof and other known components.

Development may occur via discharge area development. In discharge area development, the photoreceptor is charged and then the areas to be developed are discharged. The development fields and toner charges are such that toner is repelled by the charged areas on the photoreceptor and attracted to the discharged areas. This development process is used in laser scanners.

Development may be accomplished by the magnetic brush development process disclosed in U.S. Pat. No. 2,874,063, the disclosure of which is hereby incorporated by reference in its entirety. This method entails the carrying of a developer material containing toner of the present disclosure and magnetic carrier particles by a magnet. The magnetic field of the magnet causes alignment of the magnetic carriers in a brush like configuration, and this “magnetic brush” is brought into contact with the electrostatic image bearing surface of the photoreceptor. The toner particles are drawn from the brush to the electrostatic image by electrostatic attraction to the discharged areas of the photoreceptor, and development of the image results. In embodiments, the conductive magnetic brush process is used wherein the developer includes conductive carrier particles and is capable of conducting an electric current between the biased magnet through the carrier particles to the photoreceptor.

### Imaging

Imaging methods are also envisioned with the toners disclosed herein. Such methods include, for example, some of the above patents mentioned above and U.S. Pat. Nos. 4,265,990, 4,584,253 and 4,563,408, the entire disclosures of each of which are incorporated herein by reference. The imaging process includes the generation of an image in an electronic printing magnetic image character recognition apparatus and thereafter developing the image with a toner composition of the present disclosure. The formation and development of images on the surface of photoconductive materials by electrostatic means is well known. The basic xerographic process involves placing a uniform electrostatic charge on a photoconductive insulating layer, exposing the layer to a light and shadow image to dissipate the charge on the areas of the layer exposed to the light, and developing the resulting latent electrostatic image by depositing on the image a finely-divided electroscopic material, for example, toner. The toner will normally be attracted to those areas of the layer, which retain a charge, thereby forming a toner image corresponding to the latent electrostatic image. This powder image may then be transferred to a support surface such as paper. The transferred image may subsequently be permanently affixed to the support surface by heat. Instead of latent image formation by uniformly charging the photoconductive layer and then exposing the layer to a light and shadow image, one may form the latent image by directly charging the layer in image configuration. Thereafter, the powder image may be fixed to the photoconductive layer, eliminating the powder image transfer. Other suitable fixing means such as solvent or overcoating treatment may be substituted for the foregoing heat fixing step.

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### EXAMPLES

### Example 1

Latex preparation. About 80.7 grams of a poly(propoxylated Bisphenol A-co-fumarate) resin and about 53.8 grams of a branched poly(propoxylated Bisphenol A-co-fumarate) resin, were combined with about 15.5 grams of carnauba wax and approximately 1.5 grams of DFKY-C7 lanthanide fluorescent agent (commercially available from Risk Reactor, Huntington Beach, Calif.), in about 1101 grams of ethyl acetate at approximately 70° C. to form a first solution. An aqueous solution of about 1.9 grams of DOWFAX 2A1 (an alkyldiphenyloxide disulfonate surfactant from Dow Chemical) and about 3 grams of concentrated ammonium hydroxide were dissolved in about 850.7 grams of deionized water at about 70° C. The first solution was combined with the aqueous solution under continuous high-shear homogenization using an IKA Ultra-Turrax T50 set to about 10,000 rpm. After about 30 minutes of homogenization, the reaction mixture was distilled at about 80° C. for about two hours.

The resulting emulsion was stirred for about 8 hours and thereafter strained through a 25-micron sieve and centrifuged at about 3000 rpm for about 15 minutes. The supernatant was decanted having a yield of about 588.2 grams of a white, strongly red-fluorescent latex, with about 23.5% solids and an average particle size of about 167 nm.

### Example 2

Toner particle preparation. About 225 grams of the latex prepared in Example 1 above was combined with about 1.87 grams of DOWFAX 2A1 in about 372 grams of deionized water in a glass reactor and adjusted to a pH of about 3.3 with 0.3N nitric acid. The latex mixture was homogenized using an IKA ultra-Turrax T50 running at about 4,000 rpm while adding a mixture of about 2.2 grams of 10% by weight aluminum sulfate (Al₂(SO₄)₃) and about 19.8 grams of deionized water over about one minute. The resulting mixture was then homogenized for about five minutes and then heated to about 45° C. over about 30 minutes while stirring at about 495 rpm until a particle size of about 5.04 microns was reached.

A solution of about 131.8 grams of the latex prepared in Example 1 and about 0.72 grams of DOWFAX 2A1 was then added to the reactor. The pH was adjusted to about 3.3 with 0.3 N nitric acid while the stirring rate was reduced to about 385 rpm. The reaction temperature was then raised by about 3° C. over about 30 minutes until a particle size of about 6.02 microns was reached. The pH of the solution was then adjusted to about 7.5 and the stirring rate was reduced to about 200 rpm. The reaction temperature was also increased to about 70° C. over about 40 minutes and about five drops of DOWFAX 2A1 was added.

The reaction mixture was maintained at a temperature from about 70° C. to about 75° C. for about three hours until toner particles having a particle size of about 6.21 microns were obtained. The reaction mixture was then cooled to about 25° C. and was strained through a 20-micron sieve, filtered and dried. The toner was re-suspended in deionized water for about 40 minutes and then re-filtered and re-suspended in water at about 40° C. and a pH of about 4 for about 40 minutes. The toner was thereafter re-filtered and re-suspended once again. The suspension was then filtered and lyophilized, to obtain white, brightly red-fluorescent particles having a size of about 5.9 microns, a geometric size distribution (GSD) of from about 1.27 to about 1.31, and a circularity of about 0.944.

### Example 3

The toner particles of Example 2 were blended with an iGen3 Series 9 Cyan additive package containing silica and titania and available from Xerox Corporation (Rochester, N.Y.).

The blended particles were then added to a magnetic carrier for use in a two component development system and placed into a DC12 developer housing. Unfused images on paper were produced at two different thicknesses (pile heights of toner or toner mass per unit areas). The toner mass per unit area corresponded to a standard thickness of 0.5 mg/cm² and a thicker layer, 1 mg/cm² to see if thicker layers would be required to observe the fluorescence. A solid area square pattern was printed using an oil-less fuser running at about 194 mm/s and about 180° C. The fused images were placed in a dark box and exposed to about 365 nm UV light using a UVGL-25 Compact UV lamp. The images showed a red color of the security toner when irradiated with UV light. Thus, the above process preserved the fluorescent properties of the lanthanide fluorescent agent.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A toner comprising:
a resin;
at least one fluorescent agent comprising a lanthanide complex comprising a lanthanide ion and a ligand; and
an optional wax.

2. A toner as in claim 1, wherein the resin is selected from the group consisting of polyesters, styrenes, acrylates, methacrylates, butadienes, isoprenes, acrylic acids, methacrylic acids, acrylonitriles, and combinations thereof.

3. A toner as in claim 1, wherein the resin comprises at least one amorphous resin.

4. A toner as in claim 1, wherein the resin is selected from the group consisting of poly(propoxylated bisphenol A co-fumarate) resins, branched poly(propoxylated bisphenol A co-fumarate) resins, and combinations thereof.

5. A toner as in claim 1, wherein the lanthanide ion is selected from the group consisting of praseodymium, neodymium, samarium, europium, gadolinium, terbium, dysprosium, holmium, erbium, thulium, ytterbium, and combinations thereof.

6. A toner as in claim 1, wherein the at least one fluorescent agent is invisible under visible light.

7. A toner as in claim 1, wherein the toner emits a fluorescent band with a full width at half maximum of from about 5 nm to about 25 nm upon exposure to ultraviolet light and has a fluorescent lifetime of from about 0.5 milliseconds to about 10 milliseconds.

8. A toner comprising:
a resin;
at least one fluorescent agent comprising a lanthanide complex comprising a lanthanide ion and a ligand; and
an optional wax;
wherein toner particles comprising the toner have a size of from about 1 micron to about 20 microns, and a circularity of from about 0.9 to about 0.99.

9. A toner as in claim 8, wherein the resin is selected from the group consisting of polyesters, styrenes, acrylates, methacrylates, butadienes, isoprenes, acrylic acids, methacrylic acids, acrylonitriles, and combinations thereof.

10. A toner as in claim 8, wherein the resin comprises at least one amorphous resin.

11. A toner as in claim 8, wherein the resin is selected from the group consisting of poly(propoxylated bisphenol A co-fumarate) resins, branched poly(propoxylated bisphenol A co-fumarate) resins, and combinations thereof.

12. A toner as in claim 8, wherein the lanthanide ion is selected from the group consisting of praseodymium, neodymium, samarium, europium, gadolinium, terbium, dysprosium, holmium, erbium, thulium, ytterbium, and combinations thereof, and the ligand is selected from the group consisting of bis(pyrazolyl)pyridine, tris(2,2,6,6,-tetramethyl-3,5-heptanedionato) chelate, tris(2,2,6,6-tetrakis(trifluoromethyl)-3,5-heptanedionato chelate, and combinations thereof.

13. A toner as in claim 8, wherein toner particles comprising the toner have a size of from about 2 microns to about 15 microns, and a circularity of from about 0.92 to about 0.98.

14. A toner as in claim 8, wherein the at least one fluorescent agent is invisible under visible light, and wherein the toner emits a fluorescent band with a full width at half maximum of from about 10 nm to about 20 nm upon exposure to ultraviolet light and has a fluorescent lifetime of from about 0.5 milliseconds to about 10 milliseconds.

15. A process comprising:
contacting a resin, an optional pigment, and at least one fluorescent agent comprising a lanthanide complex to form a fluorescent latex;
adding a wax to the fluorescent latex; and
recovering fluorescent toner particles.

16. A process as in claim 15, wherein the resin is selected from the group consisting of polyesters, styrenes, acrylates, methacrylates, butadienes, isoprenes, acrylic acids, methacrylic acids, acrylonitriles, and combinations thereof.

17. A process as in claim 15, wherein the resin is selected from the group consisting of a poly(propoxylated bisphenol A co-fumarate) resin, a branched poly(propoxylated bisphenol A co-fumarate) resin, and combinations thereof.

18. A process as in claim 15, wherein the lanthanide complex comprises a lanthanide ion selected from the group consisting of praseodymium, neodymium, samarium, europium, gadolinium, terbium, dysprosium, holmium, erbium, thulium, ytterbium and combinations thereof, in combination with a ligand selected from the group consisting of bis(pyrazolyl)pyridine, tris(2,2,6,6,-tetramethyl-3,5-heptanedionato) chelate, tris(2,2,6,6-tetrakis(trifluoromethyl)-3,5-heptanedionato chelate, and combinations thereof.

19. A process as in claim 15, wherein multiple lanthanide complexes having unique fluorescent signatures are added to the resin to create a customized combination of fluorescent agents within a single toner.

20. A process as in claim 15, wherein the at least one fluorescent agent is invisible under visible light, and the fluorescent toner particles emit a fluorescent band with a fill width at half maximum of from about 5 nm to about 25 nm upon exposure to ultraviolet light and possess a fluorescent lifetime of from about 0.5 milliseconds to about 10 milliseconds.
